(19) United States
(12) Patent Application Publication
(10) Pub. No.: US 2004/0036062 A1
(43) Pub. Date: Feb. 26, 2004

(54) Stake removal tool

(76) Inventor: James Toensing, Tempe, AZ (US)

Correspondence Address: James Toensing, 7930 S. Ash Avenue, Tempe, AZ, 85284, US

(21) Appl. No.: 10/224,708

(22) Filed: Aug. 20, 2002

(51) Int. Cl. B65G 7/12

(52) U.S. Cl. 254/131

(57) ABSTRACT

This invention relates to a tool for removing stakes from the ground, including those used to secure concrete forms. The tool is composed of two symmetrical handles connected by a link bar utilizing freely rotating joints. The link bar includes a feature to align the invention with the stake. A gripper is attached to each handle enabling the tool to firmly hold the stake. Each gripper is secured to a handle in a position that is slightly off center from the link bar and handle pivot. This eccentricity between the gripper and the link bar/handle pivot axis vectors the vertical force the operator applies to the handles into compressive force exerted on the sides of the stake by the grippers. Thus, the two grippers trap the stake between them and the gripping force they apply to the stake increases as the operator increases the vertical, lifting force.

### BACKGROUND OF THE INVENTION

1. Field of the Invention

This invention generally relates to mechanical tools, and more particularly to a tool for removing stakes from the ground.

2. Description of the Prior Art

Stakes are used extensively in the concrete construction trade. The stakes are commonly cylindrical in shape and made from metal, although other materials like wood or plastic may be used. When concrete is poured, it is in a semi-liquid state and forms are required to constrain the concrete to a desired boundary. The stakes, which are driven into the ground with a sledgehammer, hold the forms in place while the concrete dries.

Once the concrete has hardened, the stakes must be pulled from the ground so the forms may be removed. Currently, this is a very laborious and time consuming task caused, primarily, by two factors. First, the stakes are driven deep into hard-packed soil, often to a depth of 30+inches. A great deal of physical effort is required to free the stake from the ground and, with the primitive tools currently available, it is often easier to simply abandon the stake by driving it below the ground's surface. The loss of stakes in this manner adds an additional penalty to an already costly process. Second, the large quantity of stakes required for the average construction project amplifies the stake removal problem. Even a small improvement over existing methods will add up to a significant time savings when several hundred stakes must be pulled.

A search for prior art found several examples of stake pulling implements that attempted to solve the problems mentioned above. One example is U.S. Pat. No. 6,302,376 to Williams, dated Oct. 16, 2001, which depicts a device that relies on a fulcrum and lever arm to provide a mechanical advantage for easier removal of stakes. This device however, does not lend itself well to removing concrete form stakes for several reasons. First, the overhang on the gripping end would interfere with the form. Second, the fulcrum rests on the ground, which is often uneven or littered with concrete that has spilled over the form, possibly rendering the device useless. Another example is U.S. Pat. No. 4,671,493 to Raveneroft, dated Jun. 9, 1987. This device uses a scissor action for gripping the stake, and a lever motion, utilizing the top of the form as its fulcrum, to pull the stake from the ground. The major drawback of this device, which the previous example also shares, is that several ratcheting/clamping motions are required before the stake is fully extracted from the ground. A better design would allow the stake to be pulled using a single fluid motion.

### SUMMARY OF THE INVENTION

The invention described in this document is a device for pulling stakes from the ground, specifically those used to secure concrete forms. The stake pulling device is composed of two symmetrical handles, which are connected by a link bar utilizing freely rotating joints. The link bar includes a feature to facilitate alignment of the invention with the stake. A gripper is attached to each handle, on the end closest to the link bar, which enables the operator of the tool to get a firm hold on the upper protruding portion of the stake. The gripper is secured to the handle by a screw in a position that is slightly off center from the link bar and handle pivot so that when the operator swings the handles upwards the grippers are moved towards the stake. This eccentricity between the grippers and the link bar/handle pivot axis vectors the vertical force the operator applies to the handles into compressive force exerted on the sides of the stake by the grippers. Thus, the two grippers, mounted opposite from one another, trap the stake between them, and the gripping force they apply to the stake increases as the operator increases the vertical lifting force.

In order to pull a stake from the ground, the operator stands squarely facing the stake with his feet planted approximately shoulder width apart. With the stake centered in front of him, the operator holds the invention with one handle in each hand. The handles should be held roughly horizontal to the ground to ensure that the distance between the grippers is greater than the diameter of the stake. Next, the operator addresses the protruding stake with the invention by utilizing the alignment feature of the link bar to center the stake between the grippers. The operator then swings the handles upwards, thereby pinching the stake between the grippers. The long length of the handle compared to the small eccentricity between the gripper and the link bar/handle pivot axis provides a mechanical advantage that amplifies the gripping force applied to the stake. This force amplification, along with the knurled surface of the grippers, ensures no slippage occurs between the invention and the stake and allows the stake to be pulled from the ground in one fluid vertical motion.

A first object of this invention is to provide a stake extraction tool that allows stakes to be pulled from the ground in a single fluid movement with the minimum amount of time and effort.

Another object of the invention is to provide a force amplified, load dependent means of gripping a stake. In other words, the gripping force exerted on the stake by the invention needs to be greater than, and proportional to, the vertical force required by the operator to remove the stake. This ensures that the necessary gripping force will be applied to the stake regardless of how difficult the stake is to remove.

Another object of the invention is to provide a pair of knurled grippers designed to withstand continued use of the tool without undo deterioration in gripping performance.

Another object of the invention is to provide a compact tool that is easy to carry and use.

A further object of the invention is to provide a feature integral to the handle link bar that aligns and stabilizes the device relative to the stake, which would make the tool easier and safer to use for the operator.

Additional objects, features, and benefits will be documented in the remaining specification. Although the invention will be described in the context of stakes used to secure concrete forms, the invention may be applied to any stake. Additional benefits or applications may be obtained by modifying the invention within the scope of this disclosure.

### BRIEF DESCRIPTION OF THE DRAWINGS

The following drawings, in conjunction with the accompanying detailed description, provide a better understanding of the invention's objects:

FIG. 1 is an isometric view looking at the front of the invention engaged with a stake holding a concrete form

FIG. 2 is an isometric view looking at the back of the invention engaged with a stake holding a concrete form

FIG. 3 is a view depicting the front of the invention (the side that faces the stake).

FIG. 4 is a view depicting the back of the invention (the side that faces the operator).

FIG. 5 is a top cross-sectional view showing the invention engaged with a stake.

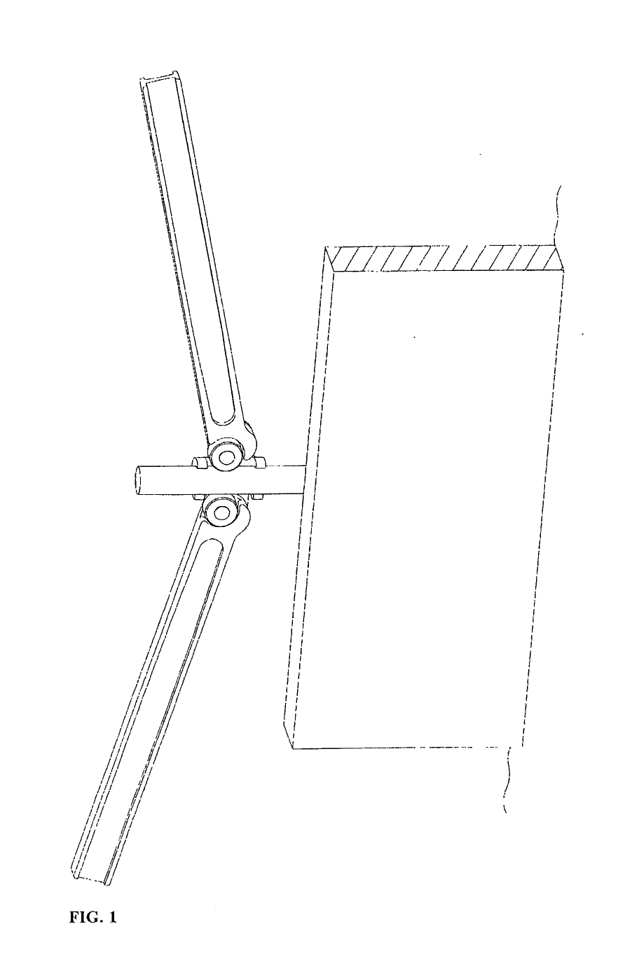

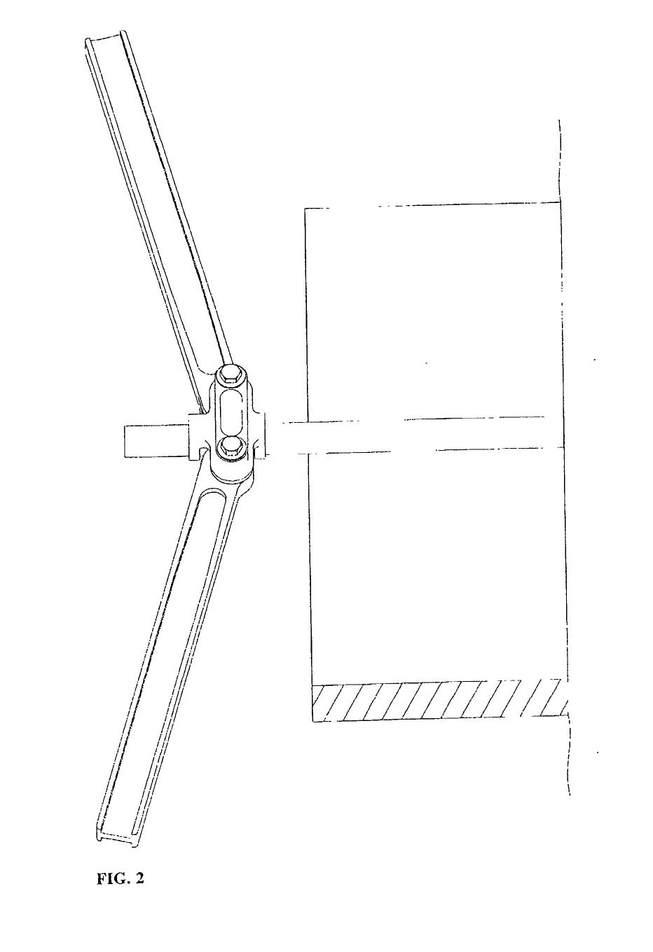

### DETAILED DESCRIPTION OF THE INVENTION

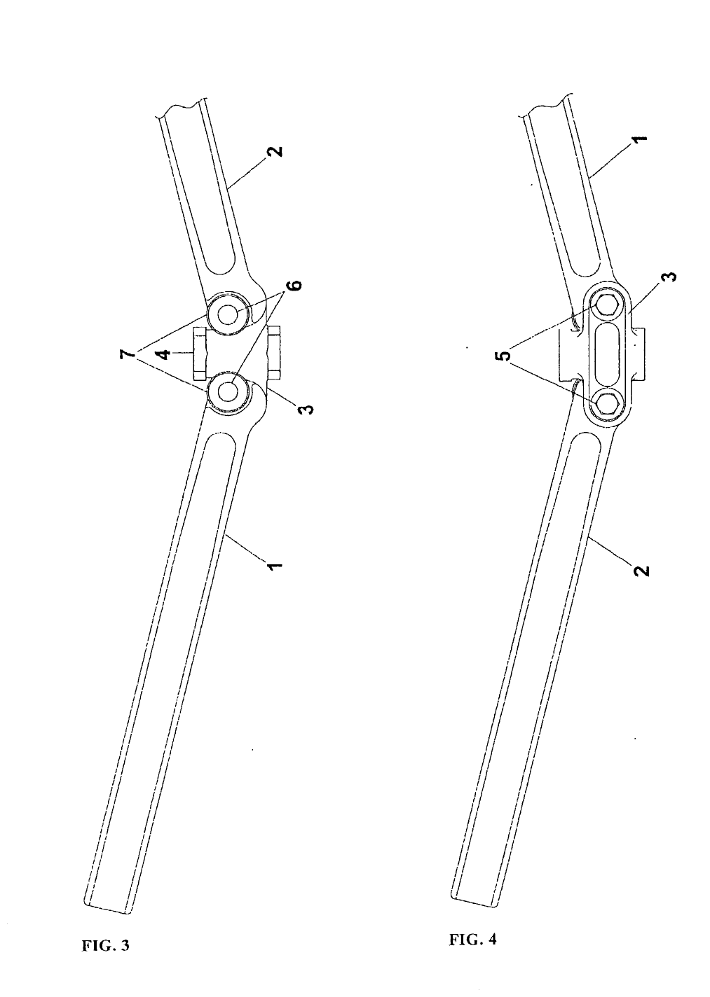

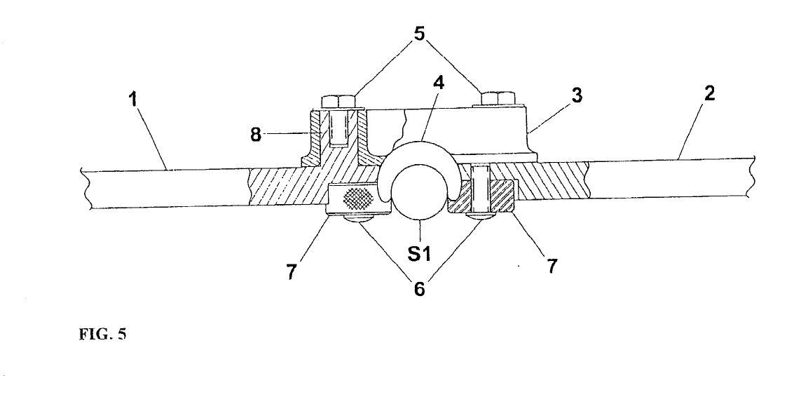

The constituent parts of the invention are labeled in FIG. 3, FIG. 4 and FIG. 5. Each of two symmetrical handles, 1 and 2, has an axle 8 on the end closest to a stake S1. Each axle 8 fits inside a hole drilled through a link bar 3. Each handle 1 and 2 is secured to the link bar 3 by a bolt 5 threaded into the end of the axle 8 to form a joint that allows each handle 1 and 2 to freely rotate about the axis of its axle 8. The link bar 3 has an alignment feature 4 that centers the invention with the stake S1 and holds the invention in a position to properly engage the stake S1. Additionally, a gripper 7 is attached to each handle 1,2 on the end closest to the stake S1 and on the opposite side of the axle 8. The grippers 7 are equally positioned on opposite sides of the stake S1 for the purpose of securely holding the stake S1 between them. Each gripper 7 is secured to the handles 1,2 by a screw 6 in a position that is eccentric from the axis of the handle's axle 8. In at least one embodiment, the grippers 7 may be patterned in such a way as to improve traction with the stake S1. For example, the grippers 7 may comprise a circumferential face that is knurled, scored, or provided with ridges. Other patterns may also be used. If the patterned face of the gripper 7 becomes worn, it may be rotated by loosening its mounting screw 6, and moved to provide a fresh, unused patterned gripping surface for future engagement with the stake S1.

As previously stated, the axis of the gripper 7 and the axis of the handle axle 8 are offset. This eccentricity allows the grippers 7 to move on an arc centered on the handle axles 8. Since the axes of the grippers 7 are located above a horizontal plane, which runs parallel to the ground and normal to the handles 1,2, created. by the handle axle 8 axes, the handles 1,2, when lifted upwards by the operator of the invention, cause the grippers 7, which rotate with their constituent handles 1,2 about the axle 8, to move closer together until they come into contact with the stake S1. The eccentricity also creates an angle between the horizontal plane through the handle axle 8 axes and a plane, normal to the handle, through the axis of the handle axle 8 and the line of contact between the gripper 7 and the stake S1. This angle, dubbed the touch point angle, is an essential part of the invention's geometry and serves to transform and amplify the vertical force applied to the handles 1,2 by the operator into compressive force exerted on the sides of the stake S1 by the grippers 7. The compressive force exerted on the stake S1 is influenced by the touch point angle and the ratio of the handle 1,2 length to the eccentricity. Since the length of the handle 1,2 is large in comparison to the small eccentricity between the axes of the gripper 7 and the axle 8, a mechanical advantage is realized that amplifies the operator supplied force and produces a self-energizing effect since the force exerted on the stake S1 is greater than the force applied to the handles 1,2 by the operator. Furthermore, the compressive force increases as the handles 1,2 are lifted upwards, and the grippers 7 are subsequently brought closer together, due to the touch point angle, which further enhances the grip on the stake S1.

The stake removal tool may be used, in one embodiment, by an operator standing squarely facing the stake S1 with his feet planted approximately shoulder width apart. With the stake S1 centered in front of him, the operator's right band is placed on handle 1 while the operator's left hand is placed on handle 2. Utilizing the stake alignment feature 4, which is part of the link bar 3, the invention is placed into position with the stake S1. With the stake S1 properly centered between the grippers 7 the operator then applies a vertical force to the handles 1,2, which engage the grippers 7 with the stake S1. Grippers 7, in at least one embodiment, slightly penetrate the stake S1 when a vertical force is applied to handles 1,2, as described. Applying additional vertical force allows the stake S1 to be pulled easily, in one fluid motion, from the ground.

In most cases, a simple vertical force applied to the handles 1,2 is all that is required to pull the stake S1 from the ground. However, several factors, including soil condition, the depth of the stake below the ground's surface, and imperfections on the stake's surface may dramatically increase the amount of vertical force required to remove the stake. If this occurs, the invention offers a unique advantage that allows even the most stubborn stake to be pulled from the ground. While keeping a small amount of vertical force applied to the handles 1,2 (necessary to keep the grippers 7 engaged with the stake S1) the operator can apply opposing horizontal forces to the handles 1,2, which twist the stake S1 about its vertical axis. The twisting motion helps break the static friction between the stake and ground. With the static friction greatly reduced the stake S1 may be pulled from the ground as previously described.

Another unique advantage provided by the invention is that it provides the additional use of gripping/holding any object whose dimensions permit it to be inserted between the first and second grippers 7 of the tool for the purpose of exerting control over the object. The additional control provided by using the tool in the aforementioned manner would allow the operator of the tool to do useful work either on or with that object.

The description and drawings describing the invention merely serve as one example of the invention's many forms. One alternate form of the invention involves reconfiguring the handles 1,2 to allow for additional methods of applying the lifting force, using an electric or gas motor to replace the physical effort of a human operator for instance, necessary to remove the stake S1. Another alternate form allows the invention to be used with stakes possessing different cross sectional shapes, such as rectangular or hexagonal, by modifying the shape of the grippers 7, the distance between the grippers 7, the touch point angle, or other geometric parameters consistent with this document. Several other modifications and variations may be made to the invention's design and construction without departing from the scope of the invention as described in this document and following claims.

What I claim as my invention is:

1. A tool for removing stakes from the ground comprising:
a first gripper attached to a first handle having a first axle shaft; a second gripper attached to a second handle having a second axle shaft; wherein the first and second handles are coupled together by a link bar interfaced with the first and second axle shafts that allow the first handle to freely rotate about a first axle axis and the second handle to freely rotate about a second axle axis.

2. A tool for removing stakes from the ground as set forth in claim 1, where the axis of each gripper is offset from the axis of its constituent handle axle; wherein the axis of each gripper is located above a plane, when the tool is engaged in a stake pulling position, passing through the first arid second handle axle axes, which, together with the aforementioned offset, allow the first and second grippers to rotate with their constituent handle, about the handle axle's axis, thereby causing the first and second grippers to move closer together, eventually coming into contact with the stake, when the first and second handles are manipulated in such a way as to extract the stake from the ground.

3. A tool for removing stakes from the ground as set forth in claim 1, wherein the length of the first and second handles, which act as lever arms, is greater than the offset distance between the first and second handle axle axes and the corresponding axes of the first and second grippers.

4. A tool for removing stakes from the ground as set forth in claim 1, whose link bar includes an alignment feature that allows the tool to be positioned on a stake quickly and easily, while also providing the optimum orientation of the tool's first and second grippers with the stake.

5. A tool for removing stakes from the ground as set forth in claim 1, which provides a platform for mounting other accessory tools, which enhance the utility and extend the range of useful work the invention can accomplish.

6. A tool for removing stakes from the ground as set forth in claim 1, whose first and second handles are reconfigurable to allow additional methods of applying the lifting force necessary to remove a stake.

7. A method of removing stakes from the ground using a stake removal tool comprising:
a first gripper; a second gripper; a first handle; and a second handle coupled to the first handle with a link bar, the method comprising the steps of:
positioning a stake between the first gripper and the second gripper;
contacting the stake with the first and second grippers;
applying a vertical force to the first and second handles such that the first and second grippers penetrate the stake; and
twisting the stake about a vertical axis of the stake.
